(19) United States
(12) Patent Application Publication
(10) Pub. No.: US 2007/0282742 A1
(43) Pub. Date: Dec. 6, 2007

(54) Method and Apparatus for Payment Processing

(76) Inventors: Linda Schrupp, Hanover, MN (US); Brenda Berry, Overland Park, KS (US); Rick Abrahamson, Bloomington, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/741,286

(22) Filed: Apr. 27, 2007

(51) Int. Cl. G06Q 40/00

(52) U.S. Cl. 705/40

(57) ABSTRACT

A method of processing a government program check submitted by a vendor to its bank for deposit is described. A payment processor receives at a check processing station check data for a check accepted by a vendor, where the check data includes one or more fields to be examined for conformity to a set of processing rules governing payment. Responsive to the check data, the payment processor determines whether the check conforms to the processing rules applicable to the vendor accepting the check and also determines whether or not a non-conformity found is resolvable with an ACH debit adjustment. Responsive to a determination that the non-conformity found is resolvable with an ACH debit adjustment, the payment processor applies computation logic to determine the amount of the debit adjustment; and issues an ACH debit transaction to effect the debit adjustment.

### BACKGROUND OF THE INVENTION

The present invention relates to an apparatus and methods for processing government checks or similar payment instruments used for payment at stores. More specifically, the present invention relates to a system for processing WIC payment checks or similar payment instruments and making payments to vendors who accept such checks/instruments, based on whether the check/instrument is in proper form and complies with applicable payment rules.

The WIC (Women, Infant and Children) program is a USDA-funded government service implemented by states to provide nutritional education and food prescriptions to qualified women and children. The food prescription is based on need. The program provides payment for foods prescribed to assist with nutritional problems. Government units have WIC checks printed to pay for prescribed nutritional items to be purchased within periodic, defined intervals. A WIC check is in effect a blank check, usable by a WIC recipient for purchase of the food prescription, with the purchase amount filled in by the vendor providing the foods listed. Other similar programs providing check or similar payment instruments to pay for goods or services provided as benefits also exist or may be established. The vendors that wish to participate in such programs enter into agreements with the government entity that determine how checks are to be submitted, processed and paid, if conforming to the rules, or rejected, if non-conforming.

The purchase amount is entered on the check by the retailer and is subject to limits. Grocery and other retail stores supplying the WIC prescribed items (WIC vendors) get paid based on what food prescription is stated in the check and a maximum price established for that food prescription and a peer group of stores. For example, Walmart and Target, as large, high volume, discount retailers are in the same group and have a lower maximum price than a small convenience store or an up-scale food market. Each of these latter vendors might be in a separate peer group permitted to charge a higher price for the same food prescription.

States set up WIC programs, review recipient needs, define food prescriptions, cause checks to be issued and pay WIC vendors who receive and deposit the checks. In fiscal 2000 WIC served an average of 7.2 million participants per month and had program costs of almost $4 billion. Participants get one or more monthly checks. Because of the volume of WIC checks processed, payment processors assist the state programs in handling checks. In particular, they assist states by checking for compliance with the state payment rules, including the permitted maximum payments.

The WIC vendor receives the WIC check from a WIC recipient who is purchasing the food prescription. The WIC recipient and the WIC vendor both insert information to complete the check. The WIC vendor then submits the check to its bank for deposit and that bank credits the WIC vendor's account the amount shown on check, subject to its later possible rejection. The check goes into the Federal Reserve System based on the routing and transit number on the check. It is presented for payment to a destination institution holding state funds. For control and cost containment purposes, states do not simply have the checks as submitted automatically paid from a state account. Rather, the state, or a payment processor engaged by the state, reviews the checks for conformity with WIC check payment rules, such as whether the WIC vendor is entitled to the amount it entered on a check.

If a submitted check is conforming, then the processor lets it proceed; payment occurs via normal Federal Reserve settlement channels from a state account to the WIC vendor bank. If the check is non-conforming, then it will be returned to the WIC vendor bank, which will reverse the credit deposit it made for the face amount of the check and apply a returned check fee of about $5 to $20 against the vendor. In addition, if a payment processor performed the return, it will charge the state a fee (typically about $0.80 to $1.00) for processing the returned check. However, the state and the WIC vendor still need to determine what, if any, payment should be made and how to get that done. The WIC vendor may correct the non-conformities and resubmit the check to the state for special state approval and payment if the check conforms or a payment compromise is agreed on.

In the case of a check that is non-conforming only by showing an amount too high for the food prescription and WIC vendor, the state will make a payment, but in a lesser amount, in accordance with its agreement with the WIC vendor. Once that amount is determined, the state or its agent can issue an appropriate payment to the WIC vendor. The state can manually issue the WIC vendor one check, paying only the proper amount, or it can aggregate multiple returned checks and manually issue the WIC vendor in one check the total of the proper amounts for multiple, returned checks submitted by that vendor. To avoid paying vendors with paper checks, the state can determine the proper, approved payment amount for each check and each vendor and send an electronic file to its payment processor as instructions to pay the WIC vendors with ACH payments to the WIC vendors' respective accounts and in amounts as set forth in the state's approved payment file. Here the vendor will be paid but will incur not only the return fee but also another fee for the payment processor's ACH payment service.

If the state provides more information and delegates more authority to the payment processor and the WIC vendor and the state have appropriate agreements, the payment processor can not only find and initiate the return for amount-only non-conforming checks but also determine the proper payment and issue by ACH the adjusted, approved payment. This relieves the state of any need to handle payment on these returned WIC checks and speeds resolution. However, in all situations where checks are returned, the WIC vendor will pay its bank a returned check fee and the state will pay the payment processor a returned check fee, and; if payment is made later, either may incur whatever costs or payment processor fees are involved in making any adjusted payment determined to be due. Thus, for returned WIC checks that are later paid at a reduced amount, the state incurs fees and the cost of making any proper, approved payment, and the vendor at best gets that proper, approved payment, sometimes not even offsetting the returned check fee charged by its bank.

Thus, there is a need for improved WIC payment processing systems and methods that assist the WIC vendors in receiving, and the states in making, any proper payments for WIC checks that are non-conforming, that provide procedures to minimize the costs per non-conforming check and that are otherwise economically efficient.

### BRIEF SUMMARY OF THE INVENTION

The present invention, in one embodiment, is a method of processing a government program check submitted by a vendor to its bank for deposit. The method comprises a payment processor receiving at a check processing station check data for a check accepted by a vendor, where the check data includes one or more fields to be examined for conformity to a set of processing rules governing payment. Responsive to the check data, the payment processor determines whether the check conforms to the processing rules applicable to the vendor accepting the check and also determines whether or not a non-conformity found is resolvable with an ACH debit adjustment. Responsive to a determination that the non-conformity found is resolvable with an ACH debit adjustment, the payment processor applies computation logic to determine the amount of the debit adjustment; and issues an ACH debit transaction to effect the debit adjustment.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is an example of a WIC payment check, showing the basic fields.

FIG. 2 is a flow diagram of the life cycle of a WIC check, including its travel to a payment processor and the path it follows if returned. It also includes a simplified table showing the logic of an edit for payment amount performed on a WIC check, based on WIC vendor peer groups.

FIG. 3 is a high-level flow diagram showing the logic of an ACH debit used to adjust payment under a WIC check.

FIG. 4 is a flow diagram showing the ACH prenote process as employed in the system described herein.

FIG. 5 is flow diagram showing the ACH credit process as employed in the system described herein.

FIG. 6 is flow diagram showing the ACH debit process as employed in the system described herein.

FIG. 7 is a system diagram showing a payment processor system for receiving WIC check data and processing it.

FIG. 8 is a schematic diagram showing the fields used in a vendor ACH record.

### DETAILED DESCRIPTION

Overview of System and Method. The following will describe in overview the processing of a WIC check as improved by the system described herein. It should be noted that the WIC check is an example and that any other government program check or instrument with similar processing requirements, as defined in a set of processing rules governing payment or rejection could be handled by the same process. Accordingly, the invention is not limited to a WIC check. A payment made by a similar check or instrument issued for another government program (e.g., for medical services, for rationed items) and provided for payment to a vendor is within the scope of the invention.

As used herein, the following terms have the following definitions:

ACH—a funds transfer system governed by NACHA Operating Rules that provides for interbank clearing of electronic debits/credit transactions (no physical checks) for participating financial institutions. This includes successor or competitor systems aiding electronic check settlement with generally comparable functions.

Check—any instrument or negotiable payment order accepted as payment by a vendor and depositable to provide a credit to a vendor-payee's account or subaccount, sometimes called a voucher.

Check data—input to a payment processor, including an actual physical check (or similar instrument) with original signature, a paper copy of such a check, an electronic image of a check, an electronic image of one or more fields on the check, or an electronic file containing data corresponding to one or more fields on the check and any combination of the foregoing presented for payment under a government program. Such data may be derived from a card used at the point of sale as a payment device.

Edit—analysis of data or a check for conformity with a specific processing rule.

Government program—a program funded by a federal, state and/or local jurisdiction or governmental entity that issues checks or similar instruments to beneficiaries for presentation to vendors as payment for goods or services provided as benefits under the program.

Payment processor—a service provider who acts for a government program by receiving checks deposited by vendors and determining if these conform to the applicable rules for the program. The payment processor may simply cause the check to be rejected and returned or provide other services to resolve payment issues raised by the check.

Vendor—a merchant that provides goods and services to a government program beneficiary under a participation agreement with the sponsoring government entity and who accepts as payment a check issued under that governmental program and deposits it for payment subject to rules in the participation agreement.

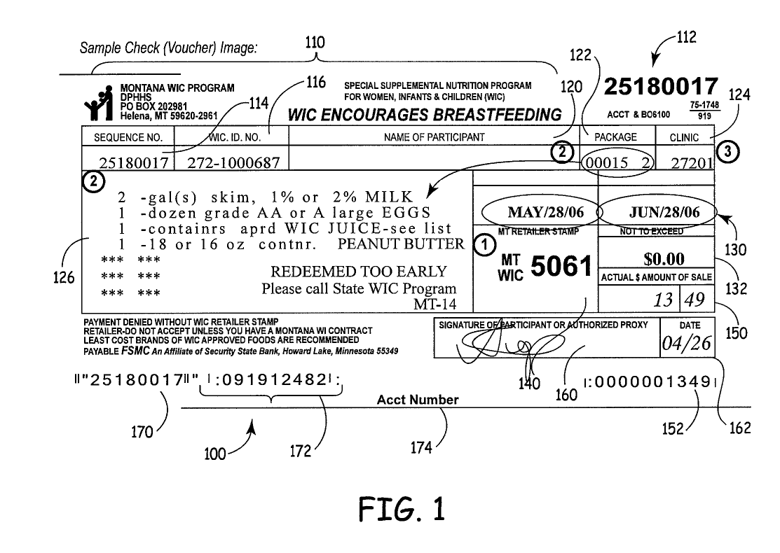

FIG. 1 is an example of one format for a WIC payment check 10, showing the basic fields present after use at vendor and when submitted for processing. As noted above, this check will typically be issued to a recipient in a set of checks, printed to pay for prescribed nutritional items (WIC food prescription) to be purchased within periodic, defined intervals. At the top of the check appears a program identification field 110 that identifies the program and the issuing jurisdiction, which is usually the payor on the check. At the rightmost portion of the top of the check is a pre-printed check number field 112, containing in this example the number “25180017.” Below these fields appear in one line a “Sequence No.” field 114, which contains the same pre-printed data as the check number field; a “WIC ID. No.” field 116; a pre-printed name of participant field 120 (content redacted here); a pre-printed package field 122 for identifying the particular food prescription; and a pre-printed clinic field 124 for identifying the clinic involved in making the food prescription. Below the line with these fields is a large information field 126 that in this case has pre-printed text listing the actual items that are part of the food prescription. In this case, the field 126 also includes a processing stamp that indicates the check was redeemed too early. To the right of the information field 126 is a pair of fields 130 that contain a pre-printed start date and an end date for use of the check.

Below the fields 130 containing a start date and an end date are a vendor/retailer stamp field 140 that is completed when the check 100 is used, a “Not to exceed” field 132 which may contain a pre-printed dollar amount (here $0.00) and an actual amount of sale field 150 that the retailer completes at the time of the purchase using the check. Below the fields 140, 150 is a signature field 160 for the WIC beneficiary signature and a date field 162, both for entries at the time the check is tendered as payment.

Across the bottom of the check are MICR-encoded fields: the check number in field 170; the routing and transit number 172 identifying the institution that should receive the check for payment from the account of the payor; an account number 174 to identify the account of the payor party (content redacted here); and a MICR coded check amount number 152 to facilitate automated processing of the amount. This amount is entered at the vendor's bank as the bank of first deposit, to correspond to the amount at field 150.

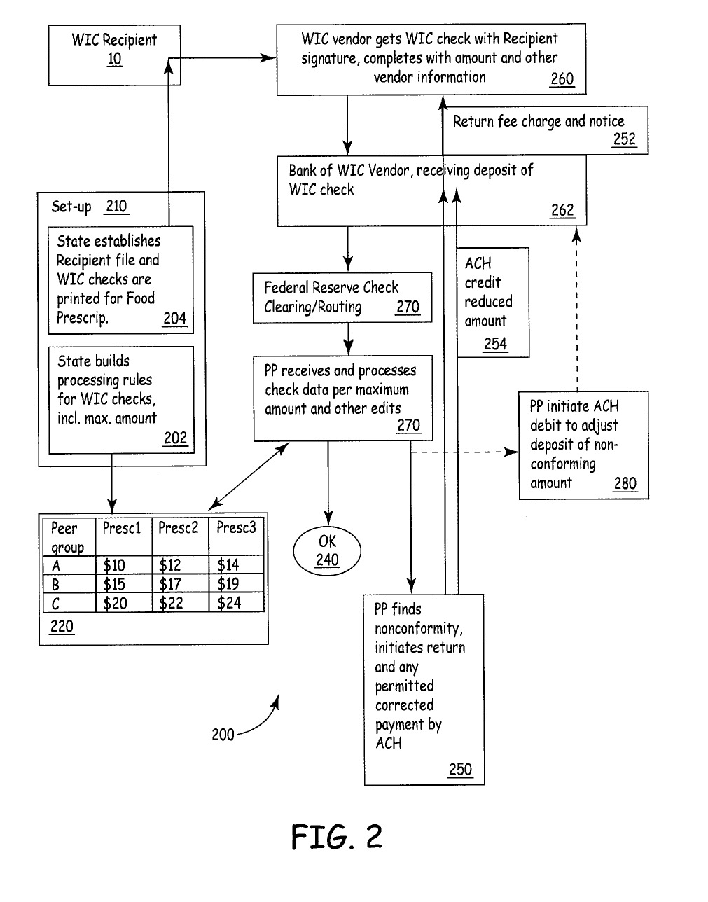

FIG. 2 shows a high level schematic block diagram of a system and method 200 for performing processing of WIC checks for a government entity, in particular, a state, where the state has engaged a payment processor. The state must set up 210 the program with various personnel, clinics and other facilities for seeing a WIC recipient (beneficiary) 10 and defining the food prescription for that recipient 10. The state also enters into participation agreements with participating vendors. The state must also build its vendor payment infrastructure, a primary part of which is a set of payment processing rules 202 that are part of the participation agreement. These may include a variety of requirements. To the extent these are to be applied by a payment processor acting for the state, the requirements may be embodied in a set of rejection or return rules, such as the following: no vendor stamp; illegible vendor stamp; invalid vendor number/stamp; redeemed to early; no signature; altered dollar amount; excessive dollar amount; altered price; second presentment; altered food package; and purchase price missing/illegible. Assuming the state has its infrastructure in place, it can process a recipient and upon determining need/eligibility issue 204 one or more (usually a sequence of) checks that a WIC recipient takes with him/her for use to purchase the food prescription over an up-coming several-month period. The processing rules are provided to the payment processor for implementation in its systems.

As further seen in FIG. 2, the processing of a WIC check 100 begins with the WIC recipient going to a vendor and making a purchase, providing a WIC check 100 as the form of payment. The vendor provides the goods, and the WIC recipient and vendor provide the signatures, stamps and other notations to complete the check as a payment instrument 260. Among the important notations is the amount of the purchase, which establishes the amount of the payment the vendor claims, entered at field 150 as shown in FIG. 1. To get its payment, the vendor deposits the check at its bank with the expectation of payment 262. Typically the vendor's bank will credit its account and present the check for clearing through the Federal Reserve System 270 (although other private clearing systems may also be used). Travel of the check for clearing is determined by the routing and transit number 172 (see FIG. 1).

In the present situation, we assume the state has engaged a payment processor (PP in FIGs.) to do processing of WIC checks to determine whether they conform or do not conform to the applicable processing rules. Accordingly, the state's processing rules will have been communicated to the payment processor and the payment processor will implement computer systems and manual procedures to perform efficient examination of the deposited checks 230. Often the checks issued to WIC recipients will be designed in consultation with the payment processor, to better fit the payment processor systems. At a minimum, the checks are issued with a routing and transit number that directs the check data to the payment processor. Conventionally, this means the actual checks are physically delivered to the payment processor for handling. In some circumstance, check data other than actual checks may be delivered to the payment processor. Such check data is sufficient for the check processor to apply the necessary processing rules in a manner similar to receiving the actual checks.

When physical checks are involved, the payment processor receives them in a cash letter consisting of batches of items that have a corresponding source of receipt. The checks are prepared and processed through high-speed reader-sorters and, as needed, manually. The processing rules are applied and the items rejected at this level are identified. The batches are reconciled and the entire cash letter balanced to the charge received by the presenting banks. The checks are image-captured and an OCR program is run to capture some of the vendor numbers (others may require manual data entry). Where the payment processor receives a check issue file from the state, the paid information and other information captured during data entry is merged with the issue information. The completed processing file may result in a printed or electronic file report, which is provided to the state.

Processing Rules. Application of the processing rules 230 requires comparison of information in various fields of a WIC check to the requirements of the processing rules (sometimes called edits). For example, to check the vendor stamp, the vendor number applied by a stamp at field 140 (see FIG. 1) is compared to a list of valid vendor numbers. If the number cannot be read or the number is not a valid number, this will result in a check return. As a second example, the signature field 160 is checked to ensure it includes a signature. If no signature is present, this results in a check return. As a further example, the date of presentment as provided with the cash letter is compared to the pair of dates in the field 130, which define the range of dates for valid use. If the presentment date is outside the range in field 130, this will result in check return.

The processing rules may be implemented as manual or automated/system edits and various edits can lead to different processing. For example in one implementation, manual edits involve: visual inspection for missing vendor, unreadable vendor, missing signature or altered check. The non-conforming items are stamped for return to the vendor who accepted the item. Some items can be re-deposited once corrected. The vendor may dispute a return by contacting the state. The state can stamp the items with an override stamp and re-deposit the item or complete a state-initiated credit using ACH.

In the system edits, other fields may be examined. The vendor number on the check may not be found in the vendor file supplied by the state. Early cashing may be found, based on dates received from the state. Late cashing also may be found, with a date calculated from a date received from the state. The system edits may also detect an item previously rejected and not allowed to be re-presented. Some or all of this logic may be implemented in software on the payment processor's data processing systems.

The edit for valid amount is among the processing rules applied for cost containment. FIG. 2 shows at 220 a highly simplified logic table of the kind that might be used to implement this part of the processing rules. The maximum payment amount processing rules embody logic that defines for each vendor peer group (e.g., group A, B or C) and each food prescription (e.g., Presc1, Presc2, Presc3) a maximum price. To use this logic, the payment processor has state-provided data identifying the peer group into which each vendor falls and needs to read the amount of the check at field 150 and/or MICR field 152. Rejection results if this amount exceeds the maximum price for the relevant food prescription. For example, under the logic of table 220, the price of $13.49 shown at field 150 of FIG. 1 would exceed the permitted amount for a vendor in group A for food prescription Presc1 or Presc2. For Presc 3 this amount would be acceptable. For vendor B, the $13.49 amount would be acceptable under logic 220 for any of Presc1, Presc2 or Presc3. Exceeding the permitted amount of the check under the logic of table 220 will result in a check return.

If a payment processor finds a check conforms to all processing rules, then the check is “OK” and proceeds to normal payment 240. The state account is debited and the vendor's account at its bank has a final credit in the amount of the check. The state's bank settles to the vendor's bank.

As noted above, a non-conformity with the processing rules leads to a returned check. Payment is refused and the payment processor returns the check back to the vendor bank 250 via the Federal Reserve channels. The vendor bank will apply a returned check fee of about $5 to $20 to the vendor and give it notice of the return 252. In addition, if a payment processor performed the return, it will charge the state a fee (typically about $0.80 to $1.00) for the returned check. However, the state and the WIC vendor still need to determine what, if any, payment should be made and how to get that done. Some non-conforming checks may not be correctable, e.g., a missing signature from a recipient that does not return to the vendor. Others are correctable. For example, a missing or illegible stamp may be remedied with a legible stamp. The check can then be resubmitted.

Payment of Adjusted Amount. If the only non-conformity is a greater-than-permitted amount, the problem can be addressed by the state paying and the vendor accepting the lesser, but maximum permitted, amount. The mistake in amount costs both the vendor and the state money. Particularly the vendor is burdened with significant returned check fees. FIG. 2 shows one way in which a returned check can be resolved with limited further expense, if the only problem is an excess payment amount. If the state and the vendor have appropriate agreements, the same table that detects a payment exceeding the allowed maximum amount for a given check, permits computation of the maximum permitted payment amount. Although the return will be initiated, if authorized, the payment processor can send an ACH payment for the maximum permitted payment amount on behalf of the state directly to the vendor account 254. This is currently done and can resolve that returned check.

In accordance with the system and method described herein, a more efficient way of processing WIC checks is proposed. In particular, for that subset of WIC checks that have only a non-conformity of amount or some other nonconformity correctible by adjusting (usually reducing) the amount paid to the vendor, the present system and method offer processing that avoids check return and thus avoids the vendor bank's return fee and expedites resolution. In the payment processor's systems, the payment processing can be set up not only to detect the excess amount but also to correct it efficiently without a returned check action under conventional check payment rules.

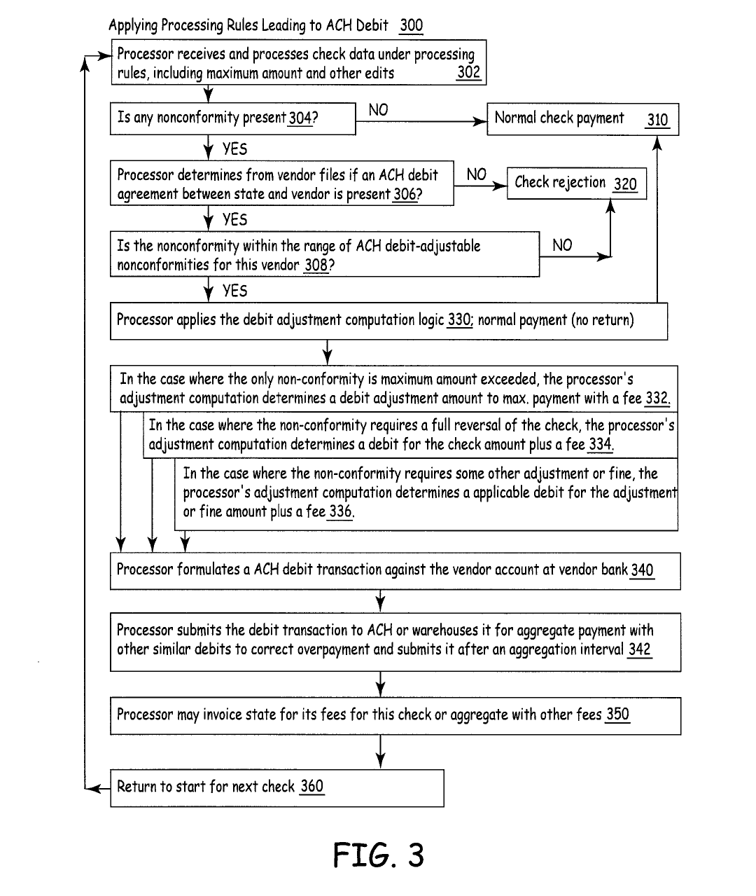

FIG. 2 indicates this alternate approach, at 280, where instead of the processing at 230 leading to a return for any non-conformity, the proper payment amount is established by letting the check clear and initiating an ACH debit adjustment as determined by the processing rules and terms of the applicable participation agreement. The ACH debit adjustment may be in any amount that is contemplated by the state and the vendor in their arrangements. Thus, the processing rules and the participation agreement may define for each vendor a range of ACH debit-adjustable nonconformities and the specific rules for calculating the amount of the debit adjustment. The debit is used to offset and reduce the net amount the state pays to the vendor on the check that would otherwise have been returned. FIG. 3 shows a more detailed flow chart of the ACH debit-based method 300.

As seen in FIG. 3, the payment processor receives and processes check data at a check processing station by applying the processing rules for maximum amount and other edits using processing rules 302. If there is no non-conformity 304, the check proceeds to normal payment 310. If nonconformity is present 304, the payment processor determines if that nonconformity is resolvable with an ACH debit adjustment. This may be done in a software-controlled or guided process, with processing rules implemented in software and data, although some steps may call for operator action, such as when a judgment on legibility is needed. The software may detect multiple nonconformities and used simple Boolean logic or more complex meta-logic (e.g., defining if-then relationships between certain non-conformities) to determine an action in response to the multiple nonconformities that will resolve them with a payment adjustment. The processor determines from vendor data files, if an ACH debit agreement between the state and vendor is present 306. If there is no such agreement, the check proceeds to rejection 320. The processor also determines if the nonconformity is within the range of ACH debit-adjustable nonconformities for this vendor 308. If it is not, again the check proceeds to rejection 320. If it is, the processor applies the debit adjustment computation logic 330 implemented in the software and data.

In one outcome, the payment processor applies the logic of the processing rules and detects that the check exceeds the maximum amount permitted, but also that this is the only non-conformity. The processing rules further define the logic to address exceeding the maximum amount permitted for a check and define the adjustment amount for this vendor, and that logic is invoked 330. Thus, when a debit agreement and applicable debit computation logic is present, for this non-conformity the payment processor does not return the non-conforming check as would usually occur, but rather causes it to proceed to normal payment at the stated amount 310. However, the payment processor computes the amount of overpayment represented by the check and the processor's fee for processing what would otherwise be a returned check 332. This amount becomes the amount of an adjusting ACH debit against the vendor account that will offset the overpayment and cause payment in the maximum amount agreed to. (For example, referring to the $13.49 check amount of FIG. 1, and the table of maximum payments in FIG. 2, a peer group A vendor would have a computed overpayment of $3.49 for Presc1 and $1.49 for Presc2.) Further assuming that the foundations for executing an ACH debit have been established as discussed below, the payment processor formulates a debit transaction for ACH processing against a vendor account at the vendor's bank 340. This account must be known and identified in the arrangements among the state, the payment processor and the vendor.

In another outcome under the processing rules, the payment processor applies the rules 302 and determines that there is such a fundamental nonconformity that no payment should be made on the check. To avoid the cost of a returned check, the payment processor may let the check proceed but issue an ACH debit transaction that fully reverses the credit that was given for the check at the vendor's bank. As with the previous outcome, the payment processor determines from vendor files, if an ACH debit agreement between the state and vendor is present 306 and determines if the nonconformity within the range of ACH debit-adjustable nonconformities for this vendor 308. If either is not the case, the check proceeds to rejection 320. If both are present, the processor applies the debit adjustment computation logic 330.

When the vendor database identifies the non-conformity as one addressable with a full reversal of the check, the processor's adjustment computation determines a debit for the check amount plus a fee 334. The state takes on some risk in having the payment processor do this, because if the ACH debit transaction to offset the credit fails (for example for NSF or an account closing), the state may have no other good route for recovery. However, if the state can collect a fee, perhaps by adding it to the offsetting ACH debit, it may recover enough from the successful ACH debits to cover the losses from those that are not successful. A vendor may be willing to pay such fees, to participate in the ACH debit program and avoid large returned check fees.

In a further outcome, the payment processor can apply an adjustment based on agreed adjustment rules for various non-conformities that lead to computed adjustments in varying amounts, as may be determined by agreed adjustment formulas or a set of fines for various non-conformities that do not require reversal of the entire check deposit amount. For example, the adjustment computation logic for such outcomes 336 determines an applicable debit for the adjustment or fine amount plus a fee 336; e.g., the logic may charge a flat fee fine or percentage adjustment for accepting checks that are slightly outside the prescribed presentment time window. Such a fine or adjustment would serve to incent a vendor to be more careful in accepting checks but would not totally reverse the deposit. The debit status could also be held open pending a discussion between the state and the vendor, with the debit amount agreed to as a compromise provided later by a communication from the state. The payment processor can then formulate the appropriate amount into an offsetting ACH debit transaction 340.

As can be seen, the computation logic for determining the applicable debit adjustment may be relatively simple or may be as complex as the parties desire to construct, based on the type of nonconformity/ies and its/their economic implications. The payment processor submits the adjusting debit into ACH or warehouses it for making an aggregate payment with other similar debits to correct overpayment of checks and submits the aggregate debit after the prescribed aggregation interval (e.g., a day or week) 342. This aggregation may help reduce fees. The payment processor determines any processing fees to be collected from the state. The payment processor may also invoice the state for its processing fees or aggregate the processing fees from multiple checks arising in an interval for later payment. At the end of processing each ACH debit for a check that would otherwise be returned, the payment processor returns 360 to the start of the process to apply the processing rules to the next check. In the likely event that not all vendors participate in the ACH debit approach to adjusting for checks by ACH debit, the vendor files embodying the state-vendor agreements are instrumental to ensure this process gets applied only where agreed to and in the manner agreed. For efficiency and speed, execution of debits may be highly or wholly automated, although they will show clearly in accounting reports available on-line or provided later as hard copy.

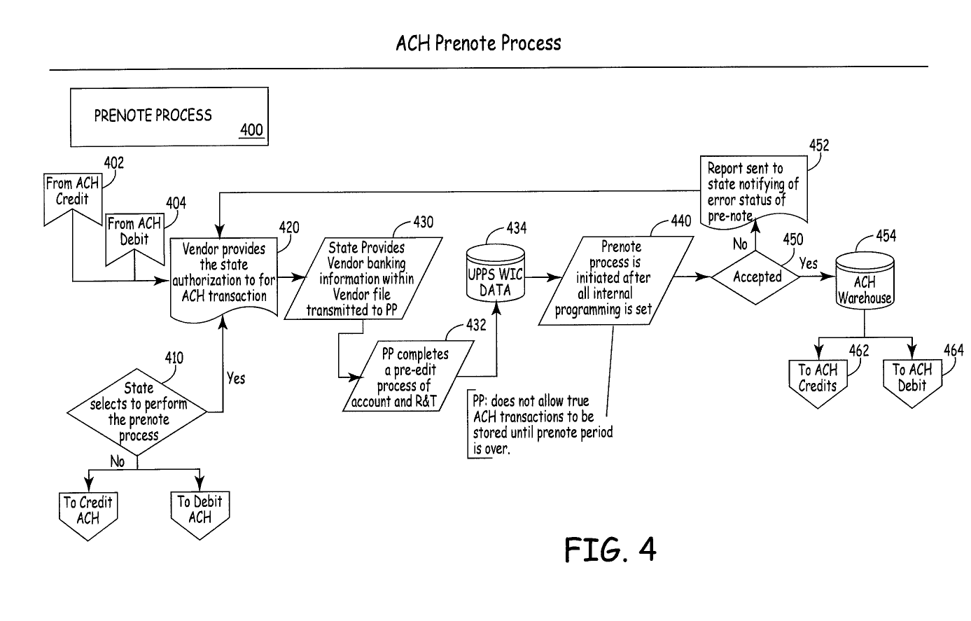

Detailed Methods for Use of ACH. Because it is desirable to use ACH for the debit adjustment just discussed and also for credits that may be part of payment processing, the payment processor and the state it serves establish procedures to set up the ACH transactions. FIG. 4 shows the ACH pre-note process 400. This is a test of the ACH payment system to validate the routing number and account number of the receiving bank or other ACH participating financial institution. There are entry points for the prenote process from ACH credit 402 and from ACH Debit 404. The state may elect to perform the pre-note process or not. If pre-note is selected, then the pre-note process by the payment processor proceeds. (If the state does not select to perform the pre-note process, then the logic flows to the credit ACH or debit ACH entry points.) The participating vendor provides the state authorization for ACH transactions to its account 420. The state provides the vendor bank account information with a vendor data file transmitted to and stored by the payment processor 430. As an initial validation, the payment processor completes a pre-edit of the account and the routing and transit number provided in the vendor file 432. The account and the routing and transit information is entered into the payment processor's Unique Payment Processing System (UPPS) WIC data processor 434. The prenote process is initiated after the payment processor's internal programming is set up 440. The payment processor awaits the result of the pre-note process. If the pre-note process does not result in acceptance, then a report is sent to the state notifying it of the error status of the pre-note 452. If the prenote process results in acceptance (validating the banking information to be used to access the vendor account), the data is stored in the payment processor's ACH warehouse 454. The system is then ready to proceed to ACH credits 462 or ACH debits 464, as required.

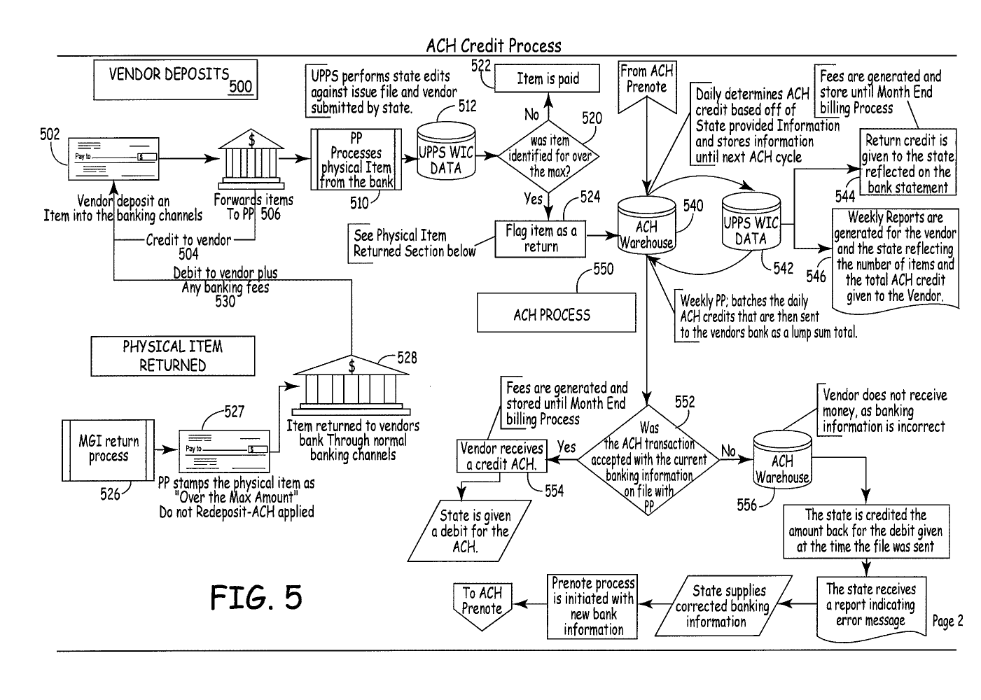

FIG. 5 shows the ACH credit process 500. The process begins when the vendor deposits an item (e.g., a WIC check) into the banking channels 502. The vendor bank provides a credit to the vendor 504 and the clearing system (e.g., Federal Reserve) forwards the item to the payment processor per the routing and transit number 506. The payment processor processes the physical item from the vendor bank 510 by entering it into the UPPS WIC data processor where the processing rules are applied 512. Among other rules, there is an edit for whether the item exceeds the maximum payment amount 520. If not (and there are no other non-conformities), the item is paid 522. If the maximum payment amount is exceeded, then the item is flagged for return. When physical return is called for, the return process is initiated at 526 and the payment processor stamps the physical item as “Over the Max Amount” 527. If the payment processor is so authorized, the vendor will nevertheless be compensated by an ACH credit and the returned item is also marked “Do not Redeposit—ACH applied”. The item is returned to the vendor bank through normal banking channels 528. The vendor will end up with a bank-initiated subtraction canceling the previously credited amount and also bear any bank imposed (returned check) fees 530.

To process an ACH credit to make payment to the vendor at a lesser, approved payment amount, the system takes the payment record for the returned item and places it in the ACH warehouse 540. The payment processor determines the approved payment amount for the ACH credit, based on the state-provided maximum payment information (or other adjustment formula, depending on the nonconformity), and stores that information until the next ACH cycle. The data is again passed to the UPPS WIC data processor at 542. From the stored data files the system issues a return credit to the state that is reflected on its bank statement 544 and weekly reports are generated for the vendor and the state, reflecting the number of items and the total ACH credit given to the vendor 546. (The payment processor's fees to the state for returns and ACH credits will be stored for a month-end billing process.) When the ACH cycle is ready (such as weekly), the daily ACH credits for approved payment amounts to a vendor are batched and then sent to the vendor's bank as a lump sum total in the ACH credit process 550. If the ACH transaction to credit the vendor is accepted with the current banking information at 552, then the vendor receives the ACH credit 554 and that is reflected as a debit against the state's account. If the ACH transaction is not accepted, 556, the vendor does not receive the credit, as the banking information to direct that action is incorrect. The state is then credited back the amount debited when the ACH credit was initiated and is provided an error report. If the state provides corrected banking information for the vendor bank, then the prenote process of FIG. 4 is reinitiated with the corrected information.

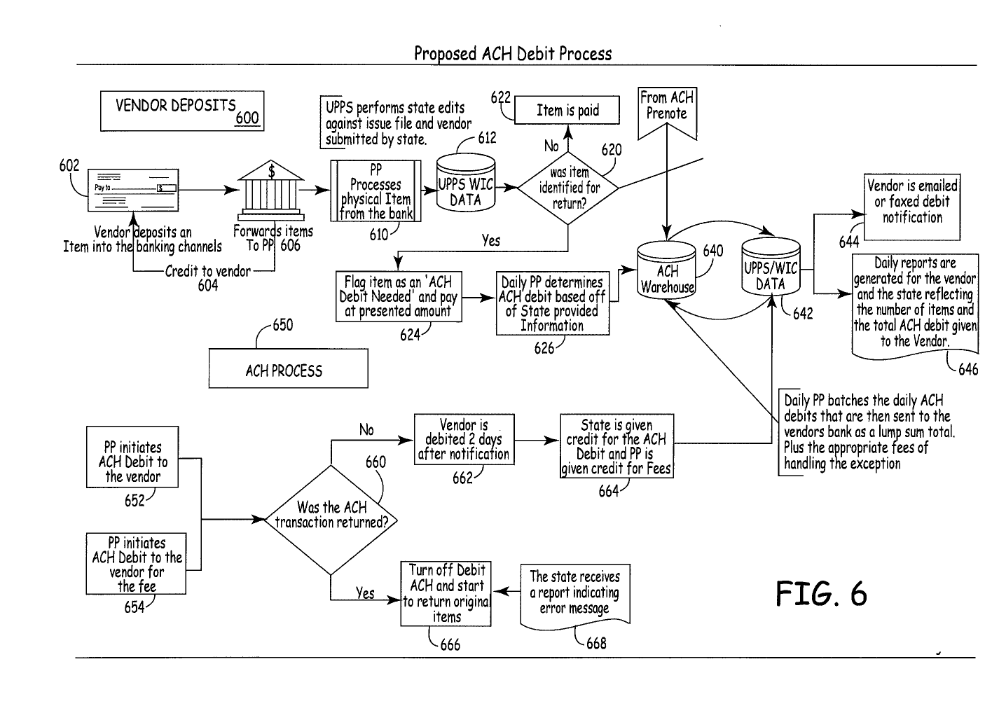

FIG. 6 shows the ACH debit process 600, which is used when a vendor is a participant in this more efficient form of resolution of certain payment non-conformities. As with the ACH credit process, the debit process begins when the vendor deposits an item (e.g., a WIC check) into the banking channels 602. The vendor bank provides a credit to the vendor 604 and the clearing system forwards the item to the payment processor per the routing and transit number 606. The payment processor processes the physical item from the vendor bank 610 by entering it into the UPPS WIC data processor where the processing rules are applied 612. Among other rules, there is an edit for whether the item is identified for return, e.g., because it exceeds the maximum payment amount or any other reason 620. If there are no non-conformities, the item is paid 622. If the maximum payment amount was exceeded or some other non-conformity is noted but the state and vendor have agreed to use ACH debit to resolve a range of non-conformities, then the item is not actually turned over to the return process; rather it is flagged as “ACH Debit Needed” and paid at the presented amount in the normal clearing process 624. This involves an over-payment, which now must be offset by an ACH debit in the appropriate amount.

The payment processor determines the corrective ACH debit amount (or adjustment) from data provided by the state, including the maximum approved payment for this vendor's group 626, and stores that information until the next ACH cycle 640. The data is again passed to the UPPS WIC data processor 642. From these files the system issues a faxed or e-mailed debit notification to the vendor 644 and daily reports are generated for the vendor and the state, reflecting the number of items and the total ACH debit given to the vendor 646. When the ACH cycle is ready (such as daily), the daily ACH debits to adjust the net payments by reducing the vendor bank account to achieve the approved payment amounts are then sent to the vendor's bank as a lump sum total in the ACH debit process 650.

In the ACH debit process, the payment processor will initiate an ACH debit to the vendor account to make the adjustment required to reduce the net credit resulting from a check that would otherwise have been returned to the approved payment amount 652. In addition, the payment processor will initiate an ACH debit to the vendor for the amount of its fee (e.g., about $3.00) for making the correction without a returned check at 654. The payment processor monitors the outcome of these debits to determine if the ACH debit transaction was returned 660. If not, then the vendor is debited the amount of the ACH debit transactions two days after the notification 662; the state is given credit for the ACH debit and the payment processor is given credit for its fees 664. This data is fed back to the UPPS WIC Data processor at 642.

If the ACH debit transaction is returned, then the “ACH Debit Needed” flag applied to the item is turned off and the payment processor will revert to its processes for performing a return of the processed items 666. The state will receive a report indicating an ACH error message was received 668.

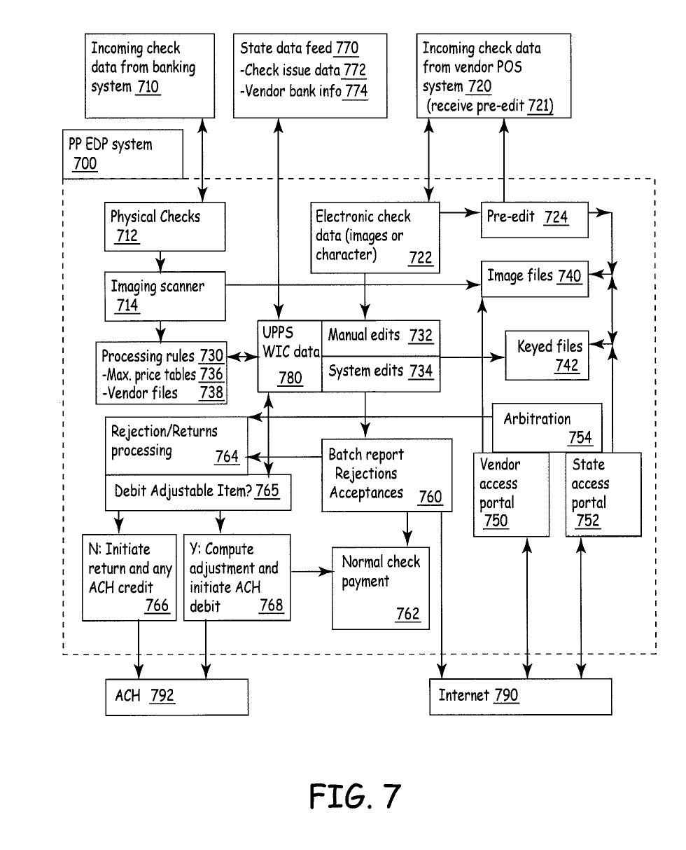

Systems at Payment Processor. FIG. 7 is a schematic block diagram of an electronic data processing (EDP) system 700 for implementing at a check processing station the payment processing methods discussed above. The EDP system may be based on any general purpose data processing system and scanning and imaging equipment compatible with the data processing system, combined with software written in any computer language suitable for implementing the functions discussed above and in this section. Among the inputs to the processing system are the incoming data from the banking system 710, i.e., the check data. This is the data flow of the payment transactions that are to be processed. FIG. 7 should not be taken to suggest a single physical location. The system 700 may consist of several linked data processing sites, each with its own unique components among those comprising the system and/or with components providing redundancy for extra capacity or use in failover.

The check data may be in the form of physical checks 712 delivered as described above. These may be fed to an image scanner 714 that captures the images for use in payment processing, for archiving and for reporting to the state and/or the vendor. The imaged items are stored in image files 740. After any imaging, the checks are subjected to the processing rules as established by the state 730, which may include Max. price tables 736 and Vendor data files 738, embodying rules for any agreed ACH credits and debits. The processing rules may be implemented as manual edits 732 or as system (software-implemented) edits 734 of data in UPPS WIC data processor 780. Some results of processing under the processing rules are stored as keyed files 742, which may include data captured automatically or entered by hand that is no longer primarily in image form. Both the image files 740 and the keyed files 742 may be made accessible at various levels to personnel at the vendor and the state. A vendor access portal 750 may be provided and include controls that limit access to that data to which a particular vendor is entitled. A state access portal 752 may be provided and include controls that limit access to the authorization of the particular state representative accessing the files. The internet 790 may be used to provide browser access, but other forms of electronic access may also be used.

As can be seen, the manual edits 732 and system edits 734 lead to batch reports 760 of returns (or return-flagged items, which may not actually be physically returned) and acceptances. The acceptances follow a path to normal payment 762. The return-flagged items will be subjected to rejected item processing, which will depend on the extent to which the payment processor has been entrusted with the right and given instructions to perform ACH credits and debits by the state and the various participating vendors. If the files on a vendor so permit, for those returned items with only a greater-than-permitted amount non-conformity, a return may be associated with the formulation of an ACH credit transaction that resolves the returned check with an appropriate payment 766 to the vendor, consistent with maximum payment rules (see FIG. 5). Also, as discussed above, a return-flagged item may not involve actual return for a check but rather normal payment 762 of an amount in excess of the permitted maximum, accompanied by the adjusting ACH debit 768 discussed above (see FIG. 6). The ACH transactions involve messages sent in accordance with NACHA rules sent to the ACH system 792. When the ACH debit is not permitted or proves unsuccessful, the item may be handled as an actual return (see 766). The processing software accesses data associated with the UPPS WIC data processor 780 or vendor files 738 to determine what actions are to be taken with respect to a particular vendor.

In some embodiments, the system 700 at the check processing station may receive additional input data. For example, it may be useful to the payment processor to have a state data feed 770 for check issue data 772 and vendor bank information 774 for setting up ACH payment records in vendor files for credits and/or debits for particular vendors. This data is fed to UPPS WIC Data processor 780. As noted above, this data may allow for additional processing rules and associated payment adjustments that may help state cost containment.

As another source of input to the system 700, the vendor point of sale (POS) may capture and transmit POS check data 720. Such data may result from various kinds of POS data capture, including scanning and image/OCR/MICR or keyed data capture. This incoming information is processed by an electronic check data component 722 that assembles image and/or character-based data files that may be used as a substitute for the check data incoming at 710 or to augment it.

One use for this POS data is to provide the MICR line, vendor ID and/or other information associated with a check number and avoid the need for its later scanning or manual entry when the check with that number arrives in the clearing process. A second use of the POS data, is to permit the payment processor to perform a pre-edit 724, applying one or more of the processing rules. If done in a time frame before check clearing, such a pre-edit might provide information back to the vendor POS 721 that permits its staff to identify checks to be corrected before they are put into the clearing process. This could reduce the number of non-conforming items and increase the rate of normal settlement on vendor checks.

A further feature of the check processing station is an arbitration management component 754 that may provide both parties simultaneously with information on a check with a non-conformity and invite each, or first one and then the other, to submit a proposed resolution, by way of payment amount and/or other terms. The arbitration management component 754 can aid the parties by recording and tracking the strings of e-mail exchanged in pursuit of resolution, suggesting alternatives and providing structured exchanges of settlement. Any specific agreed action, including a monetary adjustment coming out of the arbitration management component 754, can be communicated to the rejection/returns processing component 764, for further processing there.

Card As Source of “Check Data”. In one embodiment, the check data is derived not from a paper check issued by a government entity but by use of a card that provides value equivalent to a set of blank WIC checks and that may be swiped at a POS to make a purchase. The card may be a form of stored value card that has on it the preprinted check data as in FIG. 1 for a sequence of “checks” and permits the POS operator to enter and merge the POS data, e.g., purchase amount, with the data from the card. The presentation of the card can substitute for a signature, or a beneficiary password or other security token may be called for at the POS to complete the purchase. The “check data” resulting from POS use of the card may travel from the POS on the same electronic channels as a debit transaction, but with routing and transit again guiding the transaction to the payment processor for acceptance or rejection/return generally as described above. While this may help reduce rejected/returned transactions (providing more normal acceptances), the same processing rules can be applied with the same determination of whether or not a non-conformity found is resolvable with an ACH debit adjustment. The same ACH debit adjustments can then be applied.

In an alternate card-based embodiment, for security or other reasons, the card scanned does not itself provide all the required data for merging with the POS-supplied data to create the full set of check data needed for transaction processing. However, the data scanned from the card can include a key that permits the POS equipment or equipment elsewhere, downstream from the POS, to access a database where further beneficiary information or program information may be found and merged with the scanned data. For example, the sequence number and usage window data for the set of authorized “checks”—actually card-initiated transactions—might be kept elsewhere with the sequence number and corresponding usage window advancing with each batch of “check data” produced from use of the card. In any event, the data included in the “check data” received by the payment processor when such a card is used at the POS for a purchase may look the same as a set of data developed from a paper check. Again, this card may help reduce rejected/returned transactions (providing more normal acceptances), and the same processing rules can be applied with the same determination of whether or not a non-conformity found in “check data” is resolvable with an ACH debit adjustment.

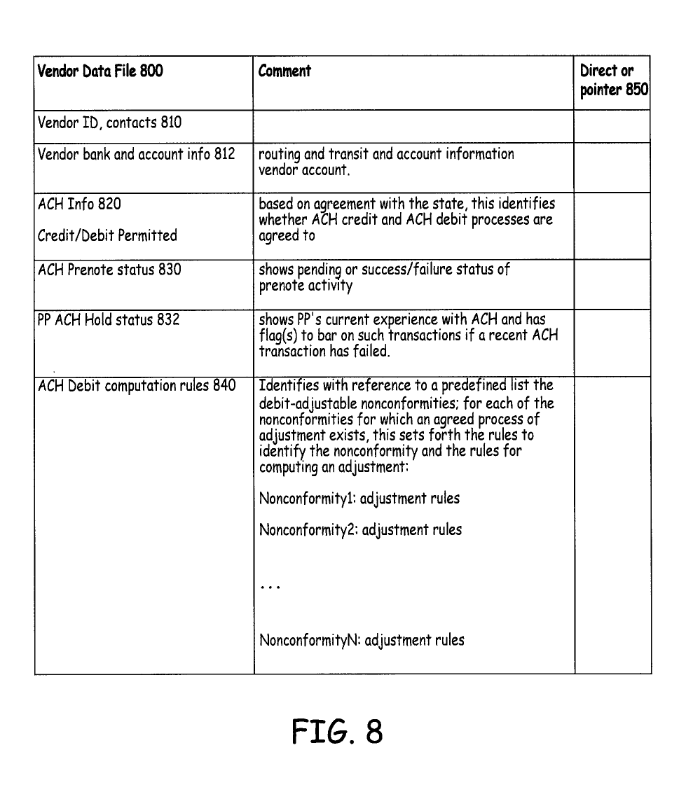

Data Structures. One feature of the present system is a vendor data file 800 that provides a focus for key information used to guide processing of a particular vendor's checks, based on information that may vary from vendor to vendor. FIG. 8 shows an example of several fields that may be used in a vendor record in vendor data file 800. The fields may be explained as follows:

Vendor Data File 800

| | |
|---|---|
| Vendor ID, contacts | |
| 810 | |
| Vendor bank and | routing and transit and account information |
| account info 812 | |
| ACH Info 820 | based on agreement with the state, this identifies |
| Credit/Debit Permitted | whether ACH credit and ACH debit processes are |
| | agreed to |
| ACH Prenote status | shows pending or success/failure status of |
| 830 | prenote activity |
| PP ACH Hold status | shows PP's current experience with ACH and |
| 832 | has flag(s) to bar on such transactions if a recent |
| | ACH transaction has failed |
| ACH Debit | Identifies with reference to a predefined list the |
| computation rules 840 | debit-adjustable nonconformities; for each of the |
| | nonconformities for which an agreed process of |
| | adjustment exists, this sets forth the rules to |
| | identify the nonconformity and the rules for |
| | computing an adjustment: |
| | Nonconformity1: adjustment rules |
| | Nonconformity2: adjustment rules |
| | . . . |
| | NonconformityN: adjustment rules |

Thus, it can be seen that the vendor data record holds information from the state files, derived from participation agreements and permits a payment processor to record the existence of ACH debit and/or credit arrangements agreed in a participation agreement between a state and a vendor 820. Further the prenote status may be maintained here 830. However, the payment processor may also have its own ACH link status field 832 that reflects its most recent experiences with the success or failure of an ACH transaction. This status can be used to note a “hold”, suspending ACH debits and/or credits, so that automated transactions do not proceed when the ACH system is not functioning for an account. This record can identify in a predefined list of codes, character strings or other indicators the range of nonconformities that the state and the vendor have agreed to resolve 840 with ACH debit and/or credit actions. Another set of fields holds the adjustment compensation rules 840, which define the computation steps to determine specific amounts for ACH transactions that the parties have agreed may be handled wholly or largely automatically. For the above records, the fields in first and second columns may contain the data itself or a pointer to the data (as indicated in the third column 850) and may be structured as a flat file or according to the rules for a relational database or other suitable database format.

Conclusion. Although the present invention has been described with reference to preferred embodiments, persons skilled in the art will recognize that changes may be made in from and detail without departing from the spirit and scope of the invention.

We claim:

1. A method of processing a government program check submitted by a vendor to its bank for deposit, comprising:
receiving at a check processing station check data for a check accepted by a vendor, said check data including one or more fields to be examined for conformity to a set of processing rules governing payment;
responsive to the check data, determining whether the check conforms to the processing rules applicable to the vendor accepting the check;
determining whether or not a non-conformity found is resolvable with an ACH debit adjustment;
responsive to a determination that the non-conformity found is resolvable with an ACH debit adjustment, applying computation logic to determine the amount of the debit adjustment; and
issuing an ACH debit transaction to effect the debit adjustment.

2. The method of claim 1 wherein the step of determining whether the check conforms to the processing rules comprises determining whether the check conforms to maximum payment amount rules and the step of applying computation logic to determine the amount of the debit adjustment comprises computing an adjusting ACH debit against the vendor account that will offset an overpayment relative to a maximum amount agreed to by the vendor.

3. The method of claim 1 wherein the step of issuing an ACH debit transaction to effect the debit adjustment comprises issuing an ACH debit against an account of the vendor where the check associated with the check data was deposited.

4. The method of claim 1 wherein the step of issuing an ACH debit transaction to effect the debit adjustment comprises issuing an ACH debit that aggregates two or more adjustments from two or more nonconforming checks accepted by the same vendor.

5. The method of claim 1 wherein step of issuing an ACH debit transaction to effect the debit adjustment comprises issuing an ACH debit that includes a processor fee for a party operating the check processing station.

6. The method of claim 1 wherein the government program is WIC and the vendor is a WIC vendor providing a food prescription.

7. The method of claim 1 wherein the government program is WIC and the vendor is a WIC vendor and the computation logic is responsive to a vendor peer group to which the WIC vendor belongs.

8. The method of claim 1 further comprising accumulating at the check processing station the check data and making such check data accessible to the payor for the government program.

9. The method of claim 1 wherein the step of determining whether the check conforms to the processing rules comprises determining whether the check conforms to maximum payment amount rules and the step of applying computation logic to determine the amount of the debit adjustment comprises computing an adjusting ACH debit computed as the amount of the check less a maximum amount based on the food prescription and on a vendor peer group to which the vendor belongs.

10. The method of claim 1 wherein the step of determining whether or not anon-conformity found is resolvable with an ACH debit adjustment comprises accessing a vendor data record with a predefined list of debit-adjustable nonconformities.

11. A system for performing processing of a government program check submitted by a vendor to its bank for deposit, comprising:
a program component for receiving at a check processing station check data for a check accepted by a vendor, said check data including one or more fields to be examined for conformity to a set of processing rules governing payment;
a program component responsive to the check data, for determining whether the check conforms to the processing rules applicable to the vendor accepting the check;
a program component for determining whether or not a non-conformity found is resolvable with an ACH debit adjustment;
a program component responsive to a determination that the non-conformity found is resolvable with an ACH debit adjustment, for applying computation logic to determine the amount of the debit adjustment; and
a program component for issuing an ACH debit transaction to effect the debit adjustment.

12. The system of claim 11 wherein the program component for determining whether the check conforms to the processing rules comprises a program component for determining whether the check conforms to maximum payment amount rules and the program component for applying computation logic to determine the amount of the debit adjustment comprises a program component for computing an adjusting ACH debit against the vendor account that will offset an overpayment relative to a maximum amount agreed to by the vendor.

13. The system of claim 11 wherein the program component for issuing an ACH debit transaction to effect the debit adjustment comprises a program component for issuing an ACH debit against an account of the vendor where the check associated with the check data was deposited.

14. The system of claim 11 wherein the program component for issuing an ACH debit transaction to effect the debit adjustment comprises a program component for issuing an ACH debit that aggregates two or more adjustments from two or more nonconforming checks accepted by the same vendor.

15. The system of claim 11 wherein the program component for issuing an ACH debit transaction to effect the debit adjustment comprises a program component for issuing an ACH debit that includes a processor fee for a party operating the check processing station.

16. The system of claim 11 wherein the government program is WIC and the vendor is a WIC vendor providing a food prescription.

17. The system of claim 11 wherein the government program is WIC and vendor is a WIC vendor and the computation logic is responsive to a vendor peer group to which the WIC vendor belongs.

18. The system of claim 11 further comprising a program component for accumulating at the check processing station the check data and making such check data accessible as image data to the payor for the government program.

19. The system of claim 11 wherein the program component for determining whether the check conforms to the processing rules comprises a program component for determining whether the check conforms to maximum payment amount rules and the program component for applying computation logic to determine the amount of the debit adjustment comprises a program component for computing an adjusting ACH debit computed as the amount of the check less a maximum amount based on the food prescription and on a vendor peer group to which the vendor belongs.

20. The system of claim 11 wherein the program component for determining whether or not a non-conformity found is resolvable with an ACH debit adjustment comprises a program component for accessing a vendor data record with a predefined list of debit-adjustable nonconformities.

21. A computer program stored in a machine readable medium for performing processing of a government program check submitted by a vendor to its bank for deposit, comprising:
a program component for receiving at a check processing station check data for a check accepted by a vendor, said check data including one or more fields to be examined for conformity to a set of processing rules governing payment;
a program component responsive to the check data, for determining whether the check conforms to the processing rules applicable to the vendor accepting the check;
a program component for determining whether or not a non-conformity found is resolvable with an ACH debit adjustment;
a program component responsive to a determination that the non-conformity found is resolvable with an ACH debit adjustment, for applying computation logic to determine the amount of the debit adjustment; and
a program component for issuing an ACH debit transaction to effect the debit adjustment.

22. The computer program of claim 21 wherein the program component for determining whether the check conforms to the processing rules comprises a program component for determining whether the check conforms to maximum payment amount rules and the program component for applying computation logic to determine the amount of the debit adjustment comprises a program component for computing an adjusting ACH debit against the vendor account that will offset the overpayment relative to a maximum amount agreed to by the vendor.

23. The computer program of claim 21 wherein the program component for issuing an ACH debit transaction to effect the debit adjustment comprises a program component for issuing an ACH debit against an account of the vendor where the check associated with the check data was deposited.

24. The computer program of claim 21 wherein the program component for issuing an ACH debit transaction to effect the debit adjustment comprises a program component for issuing an ACH debit that aggregates two or more adjustments from two or more nonconforming checks accepted by the same vendor.

25. The computer program of claim 21 wherein the program component for issuing an ACH debit transaction to effect the debit adjustment comprises a program component for issuing an ACH debit that includes a processor fee for a party operating the check processing station.

26. The computer program of claim 21 wherein the government program is WIC and the vendor is a WIC vendor providing a food prescription.

27. The computer program of claim 21 wherein the government program is WIC and vendor is a WIC vendor and the computation logic is responsive to a vendor peer group to which the WIC vendor belongs.

28. The computer program of claim 21 further comprising a program component for accumulating at the check processing station the check data and making such check data accessible to the payor for the government program.

29. The computer program of claim 21 wherein the program component for determining whether the check conforms to the processing rules comprises a program component for determining whether the check conforms to maximum payment amount rules and the program component for applying computation logic to determine the amount of the debit adjustment comprises a program component for computing an adjusting ACH debit computed as the amount of the check less a maximum amount based on the food prescription and on a vendor peer group to which the vendor belongs.

30. The computer program of claim 21 wherein the program component for determining whether or not a non-conformity found is resolvable with an ACH debit adjustment comprises a program component for accessing a vendor data record with a predefined list of debit-adjustable nonconformities.
